(19) United States
(12) Patent Application Publication
(10) Pub. No.: US 2008/0132648 A1
(43) Pub. Date: Jun. 5, 2008

(54) Process for improving the color quality in the preparation of polyoxyalkylene glycol dialkyl ethers in the presence of atmospheric oxygen

(75) Inventors: Alexander Snell, Basel (CH); Erwin Holzhauser, Ganghofen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 11/978,873

(22) Filed: Oct. 30, 2007

(30) Foreign Application Priority Data
Dec. 1, 2006 (DE) 102006056756.0

(51) Int. Cl. C08F 16/00

(52) U.S. Cl. 525/328.8

(57) ABSTRACT

The present invention provides a process for converting free hydroxyl groups of polyoxyalkylene glycols and/or polyoxyalkylene glycol monoethers by reacting at least one polyoxyalkylene glycol or at least one polyoxyalkylene glycol monoether with a base, and then alkylating or acylating it with a halohydrocarbon or acid halide in the presence of a reducing agent, the alkylation or acylation reaction being performed in the presence of atmospheric oxygen.

The present invention relates to the use of reducing agents for improving the color quality in the preparation of polyoxyalkylene glycol dialkyl ethers in the presence of atmospheric oxygen.

In industry, free OH groups in polyoxyalkylene glycols are etherified generally by the Williamson synthesis (K. Weissermel, H. J. Arpe “Industrielle Organische Chemie”, 1998, page 179) by reacting a polyoxyalkylene glycol R—OH with sodium hydroxide (or analogously with sodium) to give the corresponding alkoxide and then alkylating it with an alkyl chloride R¹—Cl according to the following reaction equations:

R¹—OH+NaOH→R¹—ONa+H₂O (I)

R¹—ONa+Cl—R→R¹—O—R+NaCl (II)

Since the alkoxide of the formula (I) formed in situ in particular is very air-sensitive, there is often undesired oxidation in the preparation of polyoxyalkylene glycol ethers with ingress of atmospheric oxygen. This forms aldehydes and other oxidation products which cause discoloration of the product. In order to achieve the high color quality desired by the customer (i.e. a low color number), additional time-consuming and costly measures in the form of bleaching with oxygen or peroxides are required. Under some circumstances, however, this damages the product, especially in the case of polyoxyalkylene glycol allyl ethers.

It was therefore an object of the present invention to provide a process with which polyoxyalkylene glycol ethers, especially allyl ethers, can be prepared with a low color number even with ingress of atmospheric oxygen.

It has been found that, surprisingly, the addition of reducing agents during the reaction allows low color numbers to be achieved.

The invention provides a process for converting free hydroxyl groups of polyoxyalkylene glycols and/or polyoxyalkylene glycol monoethers by reacting at least one polyoxyalkylene glycol or at least one polyoxyalkylene glycol monoether with a base, and then alkylating or acylating it with a halohydrocarbon or acid halide in the presence of a reducing agent, the alkylation or acylation reaction being performed in the presence of atmospheric oxygen.

The products preparable by the process according to the invention correspond preferably to the formula 1

R—O-(AO)_{y}—R¹ (1)
in which
R is hydrogen, a hydrocarbon group having from 1 to 24 carbon atoms or an R*—C(O)— group, where R* is a hydrocarbon group having from 1 to 24 carbon atoms,
R¹ is a hydrocarbon group having from 1 to 24 carbon atoms,
AO is an alkoxy group, and
y is from 1 to 200.

The process according to the invention proceeds preferably from reactants of the formula 2

H—O-(AO)_{y}—H (2)
or from reactants of the formula 3

H—O-(AO)_{y}—R¹ (3).

Alternatively to the alkylation with a halohydrocarbon (the term “alkylation” in the present context also includes the introduction of species other than alkyl radicals, for example also of allyl radicals), it is possible in the process according to the invention to perform an acylation with an acid halide of the formula (4)

R*—CO-Hal (4)
or the corresponding free acid, which forms the esters instead of the ethers described.
y is preferably from 2 to 100, especially from 3 to 50.

R may be of aliphatic or aromatic nature. R may be saturated or unsaturated. Examples of R are alkyl groups having from 1 to 24 carbon atoms, alkenyl groups having from 2 to 24 carbon atoms, phenyl, benzyl, vinyl and allyl groups. R comprises preferably from 1 to 18, especially from 2 to 4 carbon atoms.

When R in formula 1 is a hydrocarbon group having from 1 to 24 carbon atoms, these compounds are polyoxyalkylene glycol diethers which are obtainable by alkylating alkoxylates of monoalcohols having from 1 to 24, preferably from 2 to 4 carbon atoms, where R¹ comprises from 1 to 24, preferably from 2 to 4 carbon atoms.

When R in formula 1 is an R*—C(O)— group where R* is a hydrocarbon group having from 1 to 24 carbon atoms, preferably from 2 to 4 carbon atoms, these compounds are polyoxyalkylene glycol esters which are obtainable by acylating alkoxylates of monoalcohols having from 1 to 24, preferably from 2 to 4 carbon atoms.

The term “polyalkylene glycol ether” used in this application shall also include the esters, unless explicitly stated otherwise. The term “hydrocarbon group” in the present context denotes a group which consists only of carbon and hydrogen.

R¹ is preferably a radical which is derived from hydrocarbyl halides having from 1 to 24, preferably from 2 to 4 carbon atoms, by abstraction of the halogen atom. R¹ may be of aliphatic or aromatic nature. R¹ may be saturated or unsaturated. Examples of R¹ are alkyl groups having from 1 to 12 carbon atoms, alkenyl groups having from 2 to 12 carbon atoms, phenyl, benzyl, vinyl, allyl.

AO is a homogeneous or mixed alkoxy group which may be arranged randomly or in blocks, and which may comprise ethoxy, propoxy and/or butoxy groups.

The inventive polyoxyalkylene glycol ethers are prepared by reaction with a base and subsequent alkylation with a haloalkane in the presence of atmospheric oxygen and a reducing agent.

Useful bases are primarily the oxides, hydroxides and carbonates of the alkali metals and/or alkaline earth metals. Typical examples are lithium hydroxide, sodium carbonate, calcium oxide or calcium hydroxide. Preference is given to the use of sodium hydroxide and/or potassium hydroxide.

The hydrocarbyl halide is the alkylating agent. Preferred halides are chlorides.

The reducing agents used are borohydrides of the formulae BH₄, MBH₃R², MBH₂(R²)₂, MBH(R²)₃ and aluminohydrides of the formulae AlH₄, MAlH₃R², MAlH₂(R²)₂, MAlH(R²)₃, in which M is an alkali metal ion, for example lithium, sodium or potassium, and R² is CN or (OCₙH₂ₙ₊₁)ₘ where n=1-5 and m=1-4.

The invention further provides for the use of at least one reducing agent for improving the color quality of the reaction product of the conversion of free hydroxyl groups of polyoxyalkylene glycol monoethers by reacting at least one polyoxyalkylene glycol or at least one polyoxyalkylene glycol monoether with a base, and then alkylating or acylating it with at least one halohydrocarbon or acid halide in the presence of a reducing agent, the alkylation or acylation reaction being performed in the presence of atmospheric oxygen.

The content of atmospheric oxygen in the gas phase in contact with the reaction medium during the alkylation or acylation reaction in the process according to the invention is between 0.001 and 20% by volume, in particular between 0.01 and 10% by volume, especially between 0.1 and 1% by volume.

An improvement in the color quality by the process according to the invention can be assumed when the Hazen color number of the resulting process product is below 500, preferably below 250, especially below 150.

The process according to the invention will now be illustrated in detail using a few examples:

### EXAMPLE 1

### Preparation of Polyethylene Glycol Diallyl Ether with Sodium Borohydride

In a stirred reactor with temperature and pressure monitoring, a mixture of 250.0 g (0.52 mol) of a polyethylene glycol allyl ether with a mean molar mass of 500 g/mol and 0.125 g (0.003 mol) of sodium borohydride was admixed at 60° C. with 31.3 g (0.78 mol) of sodium hydroxide with stirring. Subsequently, 59.8 g (0.78 mol) of allyl chloride were added dropwise. The reactor was heated to 80° C. for continued reaction and stirred at this temperature for another 2 hours. Subsequently, excess allyl chloride was distilled off. With stirring, exactly the amount of water required to bring the amount of sodium chloride into solution was then added. After subsequent phase separation, neutralization, dewatering and filtration, the product was isolated with a Hazen color number of 85.

### EXAMPLE 2 (COMPARATIVE)

Preparation of polyethylene glycol diallyl ether without sodium borohydride Performance analogous to example 1, except without addition of sodium borohydride. A product with a Hazen color number of >>1000 (iodine color number: 16.1) was isolated.

### EXAMPLE 3

### Preparation of Polyethylene Glycol Allyl Methyl Ether with Sodium Borohydride

In a stirred reactor with temperature and pressure monitoring, a mixture of 253.5 g (1.11 mol) of a polyethylene glycol allyl ether with a mean molar mass of 230 g/mol and 0.125 g (0.003 mol) of sodium borohydride was admixed at 50° C. with 66.9 g (1.67 mol) of sodium hydroxide with stirring. Subsequently, 61.1 g (1.21 mol) of methyl chloride were introduced in gaseous form within one hour. The reactor was heated to 80° C. for continued reaction and stirred at this temperature for another 4 hours. Subsequently, excess methyl chloride was distilled off. With stirring, exactly the amount of water required to bring the amount of sodium chloride into solution was then added. After subsequent phase separation, neutralization, dewatering and filtration, a product was isolated with a Hazen color number of 20.

### EXAMPLE 4 (COMPARATIVE)

### Preparation of Polyethylene Glycol Allyl Methyl Ether without Sodium Borohydride

Performance analogous to example 3, except without addition of sodium borohydride. A product with a Hazen color number of >>1000 (iodine color number: 33.6) was isolated.

### EXAMPLE 5

### Preparation of Polyethylene Glycol Dimethyl Ether with Sodium Borohydride

In a stirred reactor with temperature and pressure monitoring, a mixture of 200.0 g (0.7 mol) of a polyethylene glycol methyl ether with a mean molar mass of 280 g/mol and 0.200 g (0.005 mol) of sodium borohydride was admixed at 50° C. with 41.9 g (1.05 mol) of sodium hydroxide with stirring. Subsequently, 43.9 g (0.87 mol) of methyl chloride were introduced in gaseous form within one hour. The reactor was heated to 80° C. for continued reaction and stirred at this temperature for another 4 hours. Subsequently, excess methyl chloride was distilled off. With stirring, exactly the amount of water required to bring the amount of sodium chloride into solution was then added. After subsequent phase separation, neutralization, dewatering and filtration, a product was isolated with a Hazen color number of 105.

### EXAMPLE 6 (COMPARATIVE)

### Preparation of Polyethylene Glycol Dimethyl Ether without Sodium Borohydride

Performance analogous to example 5, except without addition of sodium borohydride. A product with a Hazen color number of >>1000 (iodine color number: 24.8) was isolated.

1. A process for converting free hydroxyl groups of a polyoxyalkylene glycol or a polyoxyalkylene glycol monoether or a mixture thereof by
reacting a starting material of at least one polyoxyalkylene glycol or at least one polyoxyalkylene glycol monoether with a base to form a reaction intermediate, and
alkylating or acylating the reaction intermediate with at least one halohydrocarbon or acid halide in the presence of a reducing agent, the alkylation or acylation reaction being performed in the presence of atmospheric oxygen in a supernatant gas phase to provide a reaction product.

2. The process as claimed in claim 1, wherein the content in the supernatant gas phase of atmospheric oxygen during the alkylation or acylation reaction is between 0.001 and 20% by volume.

3. The process as claimed in claim 1, wherein the reaction product has a Hazen color number of less than 500.

4. The process of claim 1, wherein the reaction product corresponds to the formula 1
R—O-(AO)_{y}—R¹ (1)
in which
R is hydrogen, a hydrocarbon group having from 1 to 24 carbon atoms or an R*—C(O)— group,
R* is a hydrocarbon group having from 1 to 24 carbon atoms,
R¹ is a hydrocarbon group having from 1 to 24 carbon atoms,
AO is an alkoxy group, and
y is from 1 to 200.

5. The process of claim 1, wherein the starting material is a compound of formula 2
H—O-(AO)_{y}—H (2)
or reactants of the formula 3
H—O-(AO)_{y}—R¹ (3)
in which
R¹ is a hydrocarbon group having from 1 to 24 carbon atoms,
AO is an alkoxy group, and
y is from 1 to 200.

6. The process of claim 4, wherein y is from 2 to 100.

7. The process of claim 4, wherein R¹ is a hydrocarbon radical having from 2 to 4 carbon atoms.

8. The process of claim 1, wherein the reducing agent is selected from the group consisting of a borohydride, an aluminohydride, and mixtures thereof, wherein the borohydride has the formulae BH₄, MBH₃R², MBH₂(R²)₂, or MBH(R²)₃ and the aluminohydride has the formulae AlH₄, MAlH₃R², MAlH₂(R²)₂, or MAlH(R²)₃, in which M is an alkali metal ion selected from the group consisting of lithium, sodium, and potassium, and R² is CN or (OCₙH₂ₙ₊₁)ₘ where n=1-5 and m=1-4.

9. (canceled)
